(19) United States
(12) Patent Application Publication
(10) Pub. No.: US 2015/0381004 A1
(43) Pub. Date: Dec. 31, 2015

(54) INSULATION ARRANGEMENT FOR A HIGH-VOLTAGE MACHINE

(71) Applicant: SIEMENS AKTIENGESELLSCHAFT, München (DE)

(72) Inventors: Florian EDER, Erlangen (DE); Steffen LANG, Hallerndorf (DE); Michael PREIBISCH, Fuerth (DE)

(73) Assignee: SIEMENS AKTIENGESELLSCHAFT, München (DE)

(21) Appl. No.: 14/763,073

(22) PCT Filed: Jan. 3, 2014
(86) PCT No.: PCT/EP2014/050039

§ 371 Date: Jul. 23, 2015

(30) Foreign Application Priority Data
Jan. 23, 2013 (DE) 10 2013 201 053.2

(51) Int. Cl. H02K 3/30; H02K 15/10

(52) U.S. Cl. CPC H02K 3/30; H02K 15/105

(57) ABSTRACT

A widening bar, which has main insulation with first and second layers is used as an insulation arrangement for a high-voltage machine. The first layer has platelet-shaped mica particles and the second layer has platelet-shaped aluminum oxide particles. The insulation arrangement may be used in a generator and the method of producing the insulation arrangement is described.

### CROSS REFERENCE TO RELATED APPLICATIONS

This application is the U.S. national stage of International Application No. PCT/EP2014/050039, filed Jan. 3, 2014 and claims the benefit thereof. The International Application claims the benefit of German Application No. 102013201053.2 filed on Jan. 23, 2013, both applications are incorporated by reference herein in their entirety.

### BACKGROUND

Described below is an insulation arrangement for a high-voltage machine with a winding bar, which has a main insulation with a first and a second layer. Also described is a generator with the insulation arrangement and a method for producing the insulation arrangement.

For generating electrical energy, high-voltage machines in the form of generators are typically used. EP 1 981 150 A2 describes a generator with a rotatable rotor and a stator arranged around the rotor. The stator has a rotationally symmetrically designed laminated core, in which electrically conducting winding bars run. The laminated core is adjoined on both sides by a winding overhang, which connects the winding bars by way of connecting webs to form a closed winding.

During the operation of high-voltage machines with power outputs of over 500 MVA, rated voltages of over 10 kV can be achieved. The components are correspondingly exposed to high mechanical, thermal and electrical stresses. In particular, the winding bars running in the laminated core are therefore provided with an electrical insulation, which is intended to prevent erosion caused by electrical partial discharges and the resultant “treeing” channels.

In US 2007/0141324 A1, a description is given for example of a main insulation with mica particles, which have the form of platelets with an aspect ratio of at least 50. That is to say that the aspect ratio of length and width on one side and thickness on the other side is at least 50. Such main insulations act in an electrically and thermally insulating manner.

During the operation of the high-voltage machine, heat is produced in the conductor of the winding bar and cannot be removed because of the poor thermal conductivity of the main insulation (typically less than 0.25 W/mK). The consequence is a build-up of heat, which is particularly pronounced within the laminated core. Moreover, on account of inhomogeneities and defects in the main insulation, excessive temperatures (hot spots) may occur as a result of local partial discharges and cause the components of the main insulation to age. With advanced aging, a ground fault of the conductors may occur, which leads to complete failure of the high-voltage machine.

It is therefore necessary to provide a way to contribute to the cooling of the generator and in particular of the winding bars. It is thus known to cool generators with air, hydrogen or water, depending on the performance class.

In order to improve the thermal conductivity of the main insulation further, it is also known from US 2007/0141324 A1 to introduce thermally conductive particles into the main insulation in the course of vacuum pressure impregnation (VPI). In the VPI process, porous strips are wound onto the winding bars. The winding bars are impregnated individually (single-VPI) or together (global-VPI) in a resin under vacuum conditions, subjected to pressure and subsequently cured.

Other processes are based on resin-rich technology, in which porous strips with a polymeric insulating material at the B-stage are applied to the individual winding bars. The insulating material is in this case not completely crosslinked and can subsequently be re-heated, pressed and cured. U.S. Pat. No. 7,776,392 B2 describes a composite insulating strip which contains thermally conductive components, these being added to the resin mixture and permeating the composite strip.

### SUMMARY

Described below is an insulation arrangement with a winding bar that has along with the electrical insulating properties also thermally conductive properties. In addition, the insulation arrangement is intended to be easy and inexpensive to produce and allow itself to be integrated effortlessly in existing production processes.

An insulation arrangement for a high-voltage machine with a winding bar that has a main insulation with a first and a second layer is proposed. In this case, the first layer has mica particles in platelet form and the second layer has alumina particles in platelet form.

A method for producing an insulation arrangement for a high-voltage machine with a winding bar includes:

providing a winding bar, at least one first layer with mica particles in platelet form and at least one second layer with alumina particles in platelet form; and

applying a first and a second layer, in order to form a main insulation on the winding bar.

By introducing the second layer with alumina particles in platelet form into the main insulation, a layer that transports heat is integrated in the insulation arrangement. As a result, a better heat distribution is achieved during the operation of the high-voltage machine, and the heat distribution is made more uniform in comparison with insulation arrangements that are purely based on mica particles. Properties such as the dielectric strength, the permeability or the partial discharge resistance are also retained. An insulation arrangement that has along with the electrical insulating properties also the desired thermally conductive properties is provided.

In addition, the proposed insulation arrangement with a winding bar can be produced easily and inexpensively. In particular, the forming of the first and second layers can be integrated effortlessly in existing production processes, since the integration of the second layer only requires an insignificant modification.

A high-voltage machine is understood in the present context as meaning in particular a generator, such as a turbogenerator, with an electrical power output of for example over 50 MVA. Such generators may have power outputs of over 500 MVA and have rated voltages of over 1 kV, even over 10 kV.

For high-voltage machines, the winding bar may be formed of a composite of multiple electrical conductors, which may carry currents of several 10 kA. Copper conductors are used for example as electrical conductors.

An insulation of the winding bar may be realized as partial insulation between sub-conductors, that is to say between individual electrical conductors, or as main insulation between the composite of electrical conductors and the region with the laminated core and the winding overhang that is at ground potential. Furthermore, the main insulation may enclose the winding bar completely. The main insulation thereby forms a ring which has an outer circumferential side and an inner circumferential side around the winding bar. The thickness of the main insulating ring depends on the rated voltage of the high-voltage machine and on the production and operating conditions.

Apart from the main insulation, the winding bar may also have an inner potential control and an outer potential control, which reduce the potential within the main insulation during the operation of the high-voltage machine. Here, the inner potential control is arranged between the winding bar and the main insulation. The inner potential control is consequently arranged on the inner circumferential side of the main insulating ring. The outer potential control surrounds the main insulation on the side that is at ground potential. The outer potential control is consequently arranged on the outer circumferential side of the main insulating ring.

Multiple first and/or second layers may also be provided.

“Axial” and “radial” always relate in the present case to a center axis of the winding bar.

In one embodiment, the second layer is designed for transporting heat in the axial direction of the winding bar. Thus, an anisotropic heat conduction, which conducts heat substantially axially instead of radially, is realized in the main insulation. Since, during the operation of the high-voltage machine, the development of heat in the axial direction along the winding bar is strongest in the middle, the heat is transported through the second layer from the middle of the winding bar in the axial direction to the ends.

In a further embodiment, the alumina particles in platelet form have an aspect ratio of 10 to 100, such as 40 to 80. The aspect ratio relates here to the ratio respectively of length and width to thickness. The alumina particles are in this case formed on the basis of aluminum oxide of the formula Al₂O₃.

The alumina particles in platelet form may be oriented as lying flat in the second layer. This has the effect of reducing the erosion induced by partial discharges, and in particular the formation of “treeing” channels in the main insulation. Along with the increase in the dielectric strength, the flat orientation additionally increases the mechanical strength of the second layer.

In a further embodiment, the alumina particles in platelet form are in contact with one another. This contacting between alumina particles results in a better heat transfer between individual alumina particles, and consequently improves the thermal conductivity of the second layer.

This may involve neighboring alumina particles in platelet form butting against one another in the axial direction or at least partially overlapping. This has the effect of creating contact between the alumina particles in platelet form in the axial direction whereby the thermal conductivity of the second layer in the axial direction increases.

In order to prevent the formation of erosion channels or treeing channels in the second layer, the alumina particles in platelet form within the second layer may be arranged in multiple levels. In this case, the alumina particles in platelet form in neighboring levels may be arranged offset in relation to one another.

In a further embodiment, the alumina particles in platelet form are in a matrix. The matrix may in particular be a polymeric matrix, for example on a polysilazane basis, a polyester-imide basis or a polyether-polyol basis.

In a further embodiment, the second layer has over 40% by volume of alumina particles in platelet form embedded in a matrix. Here, % by volume relates to the total volume of the second layer. With a higher proportion by volume of alumina particles, the particles may be in contact with one another and form corresponding heat conducting paths. This has the effect of increasing the thermal conductivity up to saturation. The proportion of alumina particles may be in a superparticulate range, that is to say the thermal conductivity is at saturation. Thus, an axial thermal conductivity of the insulation arrangement that is over 2 W/mK, even over 3 W/mK, can be achieved.

In a further embodiment, the main insulation has at least two first layers, between which the at least one second layer is arranged. In particular, the main insulation may have a greater number of first layers than second layers by a factor of 5 to 50, such as 10 to 25. The thermal conductivity of the main insulation is consequently already improved significantly with a small number of second layers, which reduces the expenditure on material and has a cost-saving effect.

In a further embodiment, the second layer extends axially and circumferentially in the main insulation. The first and second layers may enclose the winding bar completely. This has the effect of ensuring on the one hand the complete insulation of the winding bar and on the other hand a uniform heat conduction within the main insulation.

In a further embodiment, the second layer in the main insulation is arranged centrally and/or offset to a circumferential side of the main insulation. In the insulation arrangement, the second layer may consequently be located centrally in the direction of the thickness within the main insulation. Thus, an increase in the uniformity of the heat distribution axially within the main insulation is achieved. In addition or as an alternative, the second layer in the insulation arrangement may be arranged offset in the direction of the thickness from the middle of the main insulation to the winding bar or to a side of the main insulation that is at ground potential. By the offset arrangement of the second layer within the main insulation, a cooling effect is achieved for the winding bar with electrical conductors or for the laminated core, which in the fitted state adjoins the side of the main insulation that is at ground potential.

The alumina particles in platelet form may also be on a carrier tape, with which the winding bar is wound. Woven fabrics, produced for example from polyester, polyethylene terephthalate (PET) or glass, are suitable as carrier tape. To form an insulating tape, the alumina particles in platelet form contained in the matrix may for example be adhesively attached to the carrier tape. As a result, the impregnatability of the individual layers is retained, so that existing production processes on the basis of the VPI process or resin-rich technology can be used.

The mica particles in platelet form may have an aspect ratio of 10 to 100, such as 40 to 80. The mica particles are formed on the basis of phyllosilicates. The mica particles may be contained in a matrix, in particular a polymeric matrix, for example on a polysilazane basis, a polyester-imide basis or a polyether-polyol basis.

Furthermore, the mica particles in platelet form may be oriented as lying flat in the first layer and arranged overlapping in multiple levels. The platelet form allows the mica particles to orientate themselves in relation to one another. The interaction of the surfaces thereby results in bonding forces, which are directly associated with the contact surfaces of neighboring mica particles. This is thermodynamically attributable in particular to the interaction of the mica particles due to van-der-Waals forces or hydrogen bridge linkages. As a result, the dielectric strength and mechanical strength of the insulation arrangement is increased.

The mica particles in the matrix consequently form mechanically stress-bearing mica paper, which can be wound around winding bars, can be impregnated by a reaction resin and has a good barrier for treeing channels. At the same time, a high resistance to partial discharges that occur during the operation of a high-voltage machine is realized.

To improve the mechanical strength further, the mica paper may be applied to a carrier tape, for instance of glass or polyester fabric. Finally, the components may be converted into a composite material. This is achieved by the mica paper being impregnated with liquid and reactive polymer by the VPI process and cured subsequently. Alternatively, resin-rich technology may also be used. The thermal conductivity of mica paper impregnated with epoxy resin on a glass or polyester fabric as a carrier tape may be for example 0.2 to 0.25 W/mK at room temperature.

In a further embodiment, the mica particles and the alumina particles are provided on the carrier tape and the first and second layers are produced by winding around the winding bar. In this way, the wound winding bars can be further processed in the course of the VPI process or on the basis of resin-rich technology. Thus, the provision of the second layer is easy and can be integrated without further effort in existing production processes.

Also proposed is a generator that includes the winding bar described above. The winding bar may in this case be led through a laminated core of the generator and have protruding ends on both sides, which are deflected at a winding overhang to form a conductor loop.

Great accumulations of heat occur in the middle of the generator or within the laminated core, and these are made more uniform by the second, conductive layer of the insulation arrangement. Thus, the second layer can conduct heat efficiently to the winding overhangs during the operation of the generator. This has the effect of lowering both the maximum temperature and the average temperature occurring in the insulation arrangement. This effect slows down the aging of the main insulation and increases the dielectric strength.

In addition, the extra costs can be kept down, since only one or a few second layers is/are already sufficient to achieve this effect. In this way there can also be a lower rated cooling of the generator. For example, cooling that is actually intended for smaller performance classes of generators may be sufficient. Consequently, in spite of possibly increased material costs for the insulation arrangement, the overall costs are lower, since the peripheral expenditure for the cooling is lower.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a longitudinal section of a generator stator with a laminated core and an insulation arrangement;

FIG. 2 is a longitudinal section of an insulation arrangement with a main insulation given by way of example;

FIG. 3 is an enlarged detail of a second layer with alumina particles in platelet form in the insulation arrangement of FIG. 2;

FIG. 4 is a graph of an axial temperature profile within the main insulation of FIG. 2;

FIG. 5 is a longitudinal section of an insulation arrangement with a further main insulation given by way of example;

FIG. 6 is a longitudinal section of an insulation arrangement with a further main insulation given by way of example; and

FIG. 7 is a sequence of a method for producing the insulation arrangement in the form of a flow diagram.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

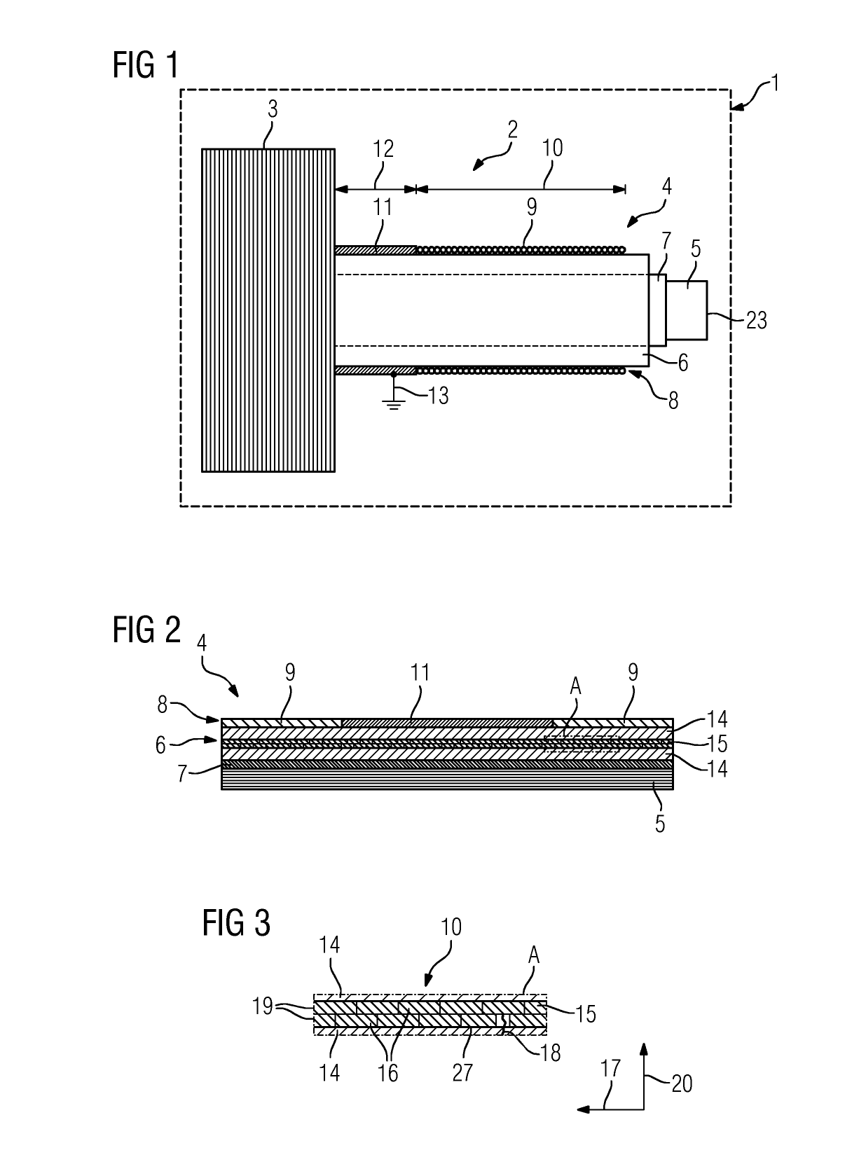

FIG. 1 shows a detail of a generator 1, which has a generator stator 2 with a laminated core 3 and an insulation arrangement 4, which has a winding bar 5.

The insulation arrangement 4 is led together with the winding bar 5 through the laminated core 3. The ends of the insulation arrangement 4 protrude from the laminated core 3. The winding bar 5 is deflected at the winding overhang (not represented) to form conductor loops. The arrangement shown in FIG. 1 is typically constructed symmetrically with winding bar ends 5 on both sides of the laminated core 3.

The winding bar 5 is enclosed by a main insulation 6. In order to avoid interfacial partial discharges between the components of the generator stator 2, the main insulation 6 is also surrounded by layers 7, 8.

Thus, a layer 7 is arranged between the winding bar 5 and the main insulation 6 as inner potential control. Between the laminated core 3 and the main insulation 6 there is also a further layer 8, which is formed as corona shielding 8. This includes an end corona shielding 9 in a first portion 10 and an outer corona shielding 11 in a second portion 12. The outer corona shielding 11 is connected to a ground 13. The outer corona shielding 11 encloses the main insulation 6 within the laminated core 3 and is continued over a partial length 12 after the winding bar 5 leaves the laminated core 3. The end corona shielding 9 directly adjoins the outer corona shielding 11. The layers 7, 8 have the effect of reducing the electrical field strength within the main insulation 6, from the inner potential control 7 to the corona shielding 8. Provided at the ends of the winding bar 5, which protrudes from the laminated core 3 on both sides, is the end corona shielding 9, which reduces the electrical potential from the outer corona shielding 11.

According to a structure that is known internally to the applicant, the main insulation 6 is formed by mica particles in platelet form in a matrix on a polyether-polyol basis, such as epoxy resin. This mica paper is also provided on a carrier tape, such as glass or polyester fabric, which is wound as main insulation 6 around the winding bar 5 of the insulation arrangement 4.

In such arrangements, the thermal conductivity of the main insulation 6 is about 0.2 to 0.25 W/mK at room temperature. Therefore, there may be a build-up of heat, in particular within the laminated core 3, which speeds up the aging process of the main insulation 6. Moreover, on account of inhomogeneities and defects in the main insulation 6, excessive temperatures (hot spots) may occur as a result of local partial discharges and cause the components of the main insulation 6 to age. With advanced aging, a ground fault of the winding bar 5 may occur, which leads to complete failure of the generator 1.

FIG. 2 shows a longitudinal section of an insulation arrangement 4 with a winding bar 5 and a main insulation 6.

The main insulation 6 has two first layers 14 with mica particles in platelet form and one second layer 15 with alumina particles in platelet form. In this case, alumina particles have a better thermal conductivity than mica particles. However, the electrical properties are comparable. Consequently, introducing the second layer 15 has the effect of integrating in the main insulation 6 a thermally conductive layer that can transport heat within the main insulation 6.

The main insulation 6 with the layers 14, 15 encloses the winding bar 5 completely. Thus, when seen in cross section, a main insulating ring which has an outer circumferential side and an inner circumferential side is formed around the winding bar 5. In the embodiment shown, the second layer 15 is arranged centrally with respect to the thickness of the main insulating ring within the same between the two first layers 14. Thus, an increase in the uniformity of the heat distribution axially within the main insulation 6 is achieved.

The second layer 15 in this case extends axially and circumferentially between the first layers 15 of the main insulation 6. In other embodiments of the main insulation 6, the ratio between the number of first layers 14 and the number of second layers 15 lies in the range of 5 to 50, such as in the range of 10 to 25. For example, the main insulation 6 may have altogether 22 first layers 15 and one or two second layers 15. The thermal conductivity of the insulation arrangement 4 is consequently already improved significantly with a small number of second layers 15, which reduces the expenditure on material substantially.

FIG. 3 shows the enlarged detail A that is indicated in FIG. 2 of the second layer 15 with alumina particles 16 in platelet form in the main insulation 6 of the insulation arrangement 4.

The alumina particles 16 in platelet form have an aspect ratio of 10 to 100 and are contained in a polymeric matrix on a polyether-polyol basis, such as epoxy resin, on a woven fabric. In this case, the alumina particles 16 in platelet form are oriented as lying flat on the second layer 15, in order to increase the mechanical strength and dielectric strength of the second layer 15. Furthermore, the alumina particles 16 in platelet form are in contact with one another. Neighboring alumina particles 16 in platelet form thereby butt against one another or overlap, at least partially, in the axial direction 17. This results in a better heat transfer between individual alumina particles 16 in the axial direction 17, and an increased thermal conductivity in the second layer 15 is achieved.

In order furthermore to prevent the formation of erosion channels or treeing channels 18 in the second layer 15, in particular in the radial direction 20 with respect to the winding bar 5, the alumina particles 16 in platelet form within the second layer 15 are arranged in multiple levels 19. In neighboring levels 19, the alumina particles 16 are arranged offset in relation to one another.

In order to realize a thermally conductive package of the second layer 15, the second layer contains 50 to 75% by volume of alumina particles 16 in platelet form. This is so because, as from a certain proportion by volume of alumina particles 16, the thermal conductivity is at saturation. Thus, an axial thermal conductivity of the main insulation 6 of over 2 W/mK, even over 3 W/mK, can be achieved.

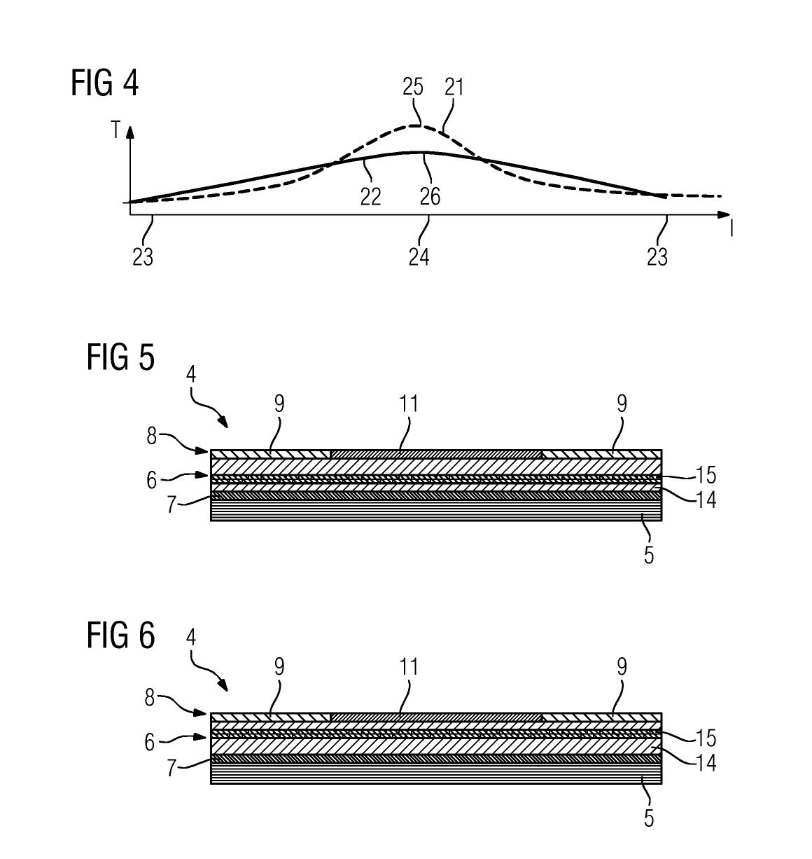

FIG. 4 shows an axial temperature profile 21, 22 within the main insulation 6 with and without the second layer 15 according to FIG. 2.

FIG. 4 shows the temperature profile 21, 22 with and without the second layer 15 in the main insulation 6, the temperature T being plotted against the axial position I along the winding bar 5. The temperature profiles 21, 22 show that the development of heat during the operation of the generator 1 is strongest in the middle 24 of the winding bar 5. Thus, the temperature profile 21 increases from the ends 23 of the winding bar 5 to the middle 24, where it reaches its maximum 25.

If a second layer 15 is provided in the main insulation 6, the temperature profile 22 shows that there is an increase in the uniformity of the heat distribution and the maximum 26 of the temperature profile 22 is less than that of the temperature profile 21. This shows that, during the operation of the generator 1, heat is transported in the axial direction 18 from the middle 24 of the winding bar 5 to the ends 23 of the winding bar 5. The heat conduction in the main insulation 6 is consequently anisotropic, because heat is carried away largely axially and not radially.

FIG. 5 shows a longitudinal section of an insulation arrangement 4 with a winding bar 5 and a further main insulation 6 given by way of example.

The embodiment represented in FIG. 5 of the insulation arrangement 4 with a winding bar 5 and a main insulation 6 corresponds substantially to that shown in FIG. 2. As a difference from FIG. 2, the second layer 15 in FIG. 5 is arranged offset in the radial direction 20 from the middle of the main insulating ring. In the fitted state of the generator 1, this means that the second layer 15 is arranged closer to the winding bar 5. By the offset arrangement of the second layer 15 within the main insulation 6, a cooling effect is achieved for the winding bar 5 during operation.

FIG. 6 shows a longitudinal section of an insulation arrangement 4 with a winding bar 5 and a further main insulation 6 given by way of example.

The embodiment represented in FIG. 6 of the winding bar 5 with main insulation 6 corresponds substantially to that from FIG. 2. As a difference from FIG. 2, the second layer 15 in FIG. 6 is arranged offset in the radial direction 20 from the middle of the main insulation 6. In the fitted state of the generator 1, this means that the second layer 15 is arranged closer to the laminated core 3. By the offset arrangement of the second layer 15 within the main insulation, a cooling effect is achieved for the laminated core 3 during operation.

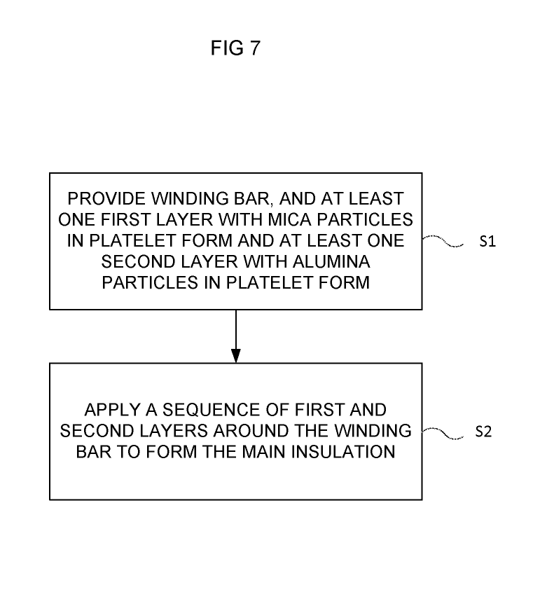

FIG. 7 shows a sequence of a method for producing the insulation arrangement 4 in the form of a flow diagram.

In S1, the winding bar 5, at least one first layer 14 with mica particles in platelet form and at least one second layer 15 with alumina particles 16 in platelet form are provided. The alumina particles 16 in platelet form are provided on a carrier tape, with which the winding bar 5 is wound. Polyester, PET or glass fabrics are suitable here as carrier tape. Thus, the impregnatability of the individual layers is retained and existing production processes on the basis of the VPI process can be used. Furthermore, the mica particles are also provided on a carrier tape.

In S2, a sequence of first and second layers 14, 15 is applied around the winding bar 5, in order to form the main insulation 6. Thus, for example, ten first layers 14 may be wound one over the other, on them a second layer 15 and on that in turn ten first layers 14. In this case, the sequence of first and second layers 14, 15 is produced by winding around the winding bar 5. Thus, the production process can be realized easily and the provision of the second layer 16 can be integrated without further effort in existing production processes.

Although the invention has been described here with reference to various exemplary embodiments, it is not restricted to these embodiments but can be modified in a variety of ways within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-15. (canceled)

16. An insulation arrangement for a high-voltage machine with a winding bar, comprising:
main insulation of the winding bar, the main insulation having first and second layers, the first layer having mica particles in platelet form and the second layer having alumina particles in platelet form.

17. The insulation arrangement as claimed in claim 16, wherein the second layer transports heat in an axial direction of the winding bar due to arrangement of the alumina particles.

18. The insulation arrangement as claimed in claim 16, wherein the alumina particles have an aspect ratio of 10 to 100.

19. The insulation arrangement as claimed in claim 16, wherein the alumina particles are oriented as lying flat within the second layer and are in contact with one another.

20. The insulation arrangement as claimed in claim 16, wherein neighboring alumina particles in the axial direction at least one of overlap and butt against one another.

21. The insulation arrangement as claimed in claim 16, wherein the alumina particles within the second layer are arranged in multiple levels.

22. The insulation arrangement as claimed in claim 21, wherein the alumina particles in neighboring levels are arranged offset in relation to one another.

23. The insulation arrangement as claimed in claim 16, wherein the second layer has over 20% by volume of alumina particles embedded in a matrix.

24. The insulation arrangement as claimed in claim 16, wherein the main insulation has at least two first layers and the at least one second layer is arranged between two of the first layers.

25. The insulation arrangement as claimed in claim 16, wherein the second layer extends axially and circumferentially in the main insulation.

26. The insulation arrangement as claimed in claim 16, wherein the second layer in the main insulation is arranged centrally.

27. The insulation arrangement as claimed in claim 16, wherein the alumina particles are provided on a carrier tape, with which the winding bar is wound.

28. The insulation arrangement as claimed in claim 16, wherein the second layer has over 35% by volume of alumina particles embedded in a matrix.

29. The insulation arrangement as claimed in claim 16, wherein the second layer in the main insulation is offset to a circumferential side of the main insulation.

30. A generator, comprising:
a winding bar; and
main insulation of the winding bar, the main insulation having first and second layers, the first layer having mica particles in platelet form and the second layer having alumina particles in platelet form.

31. A method for producing an insulation arrangement for a high-voltage machine with a winding bar, comprising:
applying main insulation to the winding bar, the main insulation including at least one first layer with mica particles in platelet form and at least one second layer with alumina particles in platelet form.

32. The method as claimed in claim 31, wherein said applying comprises winding around the winding bar a carrier tape containing the mica particles and the alumina particles.
